(19) United States
(12) Patent Application Publication
(10) Pub. No.: US 2023/0191355 A1
(43) Pub. Date: Jun. 22, 2023

(54) SYSTEM AND METHOD FOR SYNTHESIS OF ZEOLITE NANOPARTICLES IN CONTINUOUS FLOW WITH MICROFLUIDIC MICROMIXER

(71) Applicants: Petróleo Brasileiro S.A. - Petrobras, Rio de Janeiro (BR); Instituto De Pesquisas Tecnologicas Do Estado De Sao Paulo S.A. - IPT, Sao Paulo (BR)

(72) Inventors: Adriano Marim De Oliveira, Sao Paulo (BR); Catia Fredericci, Sao Paulo (BR); Karine Alves Cortez, Rio de Janeiro (BR); Martha Lucia Mora Bejarano, São Paulo (BR); Kleber Lanigra Guimarães, São Paulo (BR); Caio José Perecin, São Paulo (BR); Sheila Sousa Gomes, São Paulo (BR); Mário Ricardo Gongora Rubio, São Paulo (BR)

(21) Appl. No.: 18/067,195

(22) Filed: Dec. 16, 2022

(30) Foreign Application Priority Data
Dec. 18, 2021 (BR) 10 2021 025707 5

(51) Int. Cl. B01J 19/00; B01J 19/06; C01B 39/24; C01B 39/02

(52) U.S. Cl. CPC B01J 19/0093; B01J 19/06; C01B 39/24; C01B 39/026; B01J 2219/00891; B01J 2219/00889; B01J 2219/00873; B01J 2219/00963; B01J 2219/00833; B01J 2219/00831; B01J 2219/00822; C01P 2002/72; C01P 2004/03; C01P 2004/04; C01P 2002/85

(57) ABSTRACT

The present invention refers to a system for the process of synthesis of zeolite nanoparticles in continuous flow wherein the processes of mixing, aging and crystallization are integrated, to reduce the synthesis time. The system has a microfluidic device of the 3D crossing channels micromixer type, consisting of microchannels built in series, used to generate the reaction mixture; buffer system with addition of seeds; and a heated tubular reactor which, in turn, is used for crystallization, which takes place through a continuous hydrothermal process.

### FIELD OF THE INVENTION

Broadly, the present invention pertains to the sector of chemical processes of synthesis of nanoparticles, in particular of systems for the production of nanoparticles of zeolites in continuous flow for application in catalysis of chemical reactions applied to the field of oil refining. More specifically, the invention relates to a Y zeolite nanoparticle synthesis system, which is formed by three modules, which are a microfluidics mixer system with two inlets and one outlet, an intermediate buffer system and a tubular hydrothermal system for crystallization by hydrothermy with controlled temperature and pressure, thus generating a complete system for synthesis in continuous flow. This system is adaptable to operating conditions, allowing adjustment to obtain zeolites with specific characteristics.

### DESCRIPTION OF THE STATE OF THE ART

Currently, there is a demand for constant improvement of the performance of catalysts used in fluidized catalytic cracking (FCC), a process that within refining is primarily responsible for the conversion of heavy fractions from petroleum distillation. This demand is due to the need of increasing the scale of production of derivatives with commercial value, which can be translated into the need of increasing refining capacity.

The catalysts employed in this conversion process are based on a crystalline active component, matrices and functional ingredients.

With respect to the active component, zeolite is used and has an important influence on the performance of the catalyst. The intrinsic characteristics of these particles include the benefit of shape selectivity, an advantage that is associated with the steric restriction of certain molecules.

However, as a consequence, this steric restriction also influences the mass transfer rate of reactants and products, making it impossible for larger molecules of the reactants to access the active sites, thus enabling the occurrence of secondary reactions, since the products remain in contact with active sites for longer.

With this, an important search began for methods of zeolite synthesis that presented the same characteristics that sustain the benefit of shape selectivity, but that were also capable of reducing the negative effect of the diffusion rate.

And, since there is this demand for zeolites with greater accessibility to acidic sites, capable of increasing the conversion capacity into desired products and without loss of quality, the synthesis of zeolites on a nanometric scale (nanozeolites), with greater surface area, presents great potential for the intended application. This is due to the possibility that they have to reduce the effect of the low mass transfer rate, still maintaining the characteristic of shape selectivity.

In the literature, the nanozeolite synthesis strategy employing the method based on sol-gel and coprecipitation, followed by a hydrothermal process, has already been reported, but it has limitations related to the low synthesis yield, the long crystallization times, the difficulty in controlling the size and granulometric distribution of the particles, as well as the process of separating the particles.

Thus, the challenges encountered in the current synthesis routes of nanozeolites drive the need of searching for new approaches that are able to overcome such challenges. The flame spraying technique (Flame Spray) and the possibility of carrying out the synthesis in a confined environment, based on inverse emulsions of precursor solutions in the oily dispersed phase, are examples of strategies that have been studied in this context.

This scenario motivated the creation of a new technological approach for the hydrothermal synthesis of nanozeolites from clear homogeneous solutions (clear synthesis solutions), with the differential use of microfluidic processes of continuous flow to intensify the steps that constitute the process to obtain such particles.

Microfluidics is a technology based on the manipulation of fluids in small volumes, on the order of microliters, in microchannel systems, with great potential for scientific applications, going beyond laboratory investigations, given the possibility of miniaturization of industrial processes.

The need of improving analytical methods, making them capable of delivering reliable results quickly, gave rise to microfluidics, which since then has contributed significantly to technological innovations with miniaturized processes, precisely controlled and carried out in one operating time reduced when compared to other processes carried out in conventional ways.

Another advantage of microfluidics lies in the operating conditions, such as the flow rate used in a miniaturized process and the reduced size of the cross-section of the microchannels, which induce a laminar flow, given the low Reynolds number (Re<100), also allowing a more precise control of the reactions that occur inside the microchannels. The mass and heat transfer processes are also more efficient when compared to macrometric scales. These factors make microfluidic systems attractive for developing analytical techniques (Lab on a chip) and for exploring complex reactions.

The interest in using microfluidic technology for both scientific and industrial applications has resulted in different configurations of microfluidic systems, and the versatility in terms of micromanufacturing, types of geometries and microchannel structures is also an advantage that makes them interesting for innovation in analysis and continuous flow processes.

Regarding micromanufacturing techniques, the most used materials are glass plate, silicon wafer, elastomeric polymers such as polydimethylsiloxane (PDMS) and polymethylmethacrylate (PMMA) and also ceramics. For industrial applications, microfluidic systems in ceramic materials, specifically produced using LTCC (Low Temperature Co-fired Ceramic) technology, have features that provide conditions for large-scale operation. The green ceramic in LTCC allows the manufacturing of three-dimensional (3D) microchannels, being able to withstand high temperatures, high flows and internal pressures, enabling the scaling of microfluidic processes for different applications.

Among the possible uses of microfluidic systems built in LTCC, applications in the fields of chemical processes stand out, such as chemical microreactors, heat exchangers and micromixers. Therefore, microfluidics points to a potential for applications in different areas that aim at both fluid mixing and chemical reactions applied in processes, such as food, pharmaceutical, chemical and even the oil and gas industry.

In the synthesis of nanoparticles, microfluidics can be used as a technology to improve mixing processes and chemical reactions. This is because the laminar flow condition found in continuous flow microfluidic devices allows the controlled formation of what is called a reaction-diffusion (RD) environment that favors the control and optimization of the chemical processes that take place inside the microchannels.

Methods of synthesis of zeolites in continuous flow have been proposed in order to overcome the limitations found in methods performed in batch. Such methods usually involve the addition of seeds as a strategy to control particle size, as well as to accelerate the aging process, also reducing the total synthesis time. The crystallization process, in turn, takes place continuously, in a tubular reactor. However, the use of microfluidic mixers is not yet addressed to in this strategy, despite the potential that these devices have for acting in the step of reaction mixing and feeding the reactor, also performing this continuously. Therefore, current routes for continuous synthesis of zeolites present critical points/technical problems/limitations, among which the following stand out: the mixing process is carried out continuously, but without the use of a micromixer, which, in addition to miniaturizing the process is capable of delivering an effective mixture, and the specific obtention of Y-type zeolites, at the nanometer scale.

Thus, microfluidics presents itself as a promising technology to improve the synthesis of Y nanozeolites by continuous flow process, which can be carried out by integrating the three main steps of synthesis by hydrothermal route: mixing/nucleation, aging and crystallization.

Some proposed methods for the synthesis of zeolites in continuous flow are presented in detail in the documents described below.

Document EP0149929 addresses to a process for the production of 4A-type zeolites, in which there is continuous and simultaneous feeding of aqueous solutions of sodium silicate and sodium aluminate, thus performing continuous mixing in a venturi-type mixer, in a tubular-type reactor.

Document EP3596010 addresses to a continuous method of synthesis of zeolites of any type, in a reduced time when compared to the batch method. The method consists of feeding a tubular type crystallization reactor equipped with internal restriction systems and a pulsating device, which is operated under particular conditions, with a reaction mixture carried out continuously in a shear mixer, of the rod rotor type, which contains seeds, with the aim of eliminating the aging phase at low temperatures, and to carry out crystallization in a faster and more continuous way, using temperatures above 120° C.

Document EP3596013 addresses to a method of synthesizing X zeolite of high purity, comprising at least one step of adding seeds to the reaction mixture (which can be heated) and at least one step of crystallization at a temperature above 120° C., with reduced synthesis time, and can be conducted continuously, with crystallization in a continuous system, or semi-continuously, with crystallization carried out in batches.

Document JP2005289745 addresses to a method of synthesizing A-type zeolites, mold X and mold Y of high functionality, in continuous flow, using a multi-stage rotary reactor, which performs the mixing, feeding and synthesis of zeolites in continuous flow.

The study of an ultra-fast synthesis of BEA zeolites, without the aging step, adjusting the synthesis time from the control of the reaction mixture, using directing agents of organic structures, as well as seeds, is reported by J. Zhu et al. in the paper “Ultrafast synthesis of *BEA zeolite without the aid of aging pretreatment”, Microporous and Mesoporous Materials 268 (2018) 1-8.

The present invention differs from the mentioned documents in some respects. One of them consists of using a microfluidic micromixer, applied in the phase of obtaining the reaction mixture, which allows the miniaturization of this process and the obtaining of an efficient mixture in continuous flow. Another difference refers to the particle size, which is on a nanometric scale in the present invention. The aging step, present in some routes, is eliminated in this case; therefore, the mixing and feeding of the crystallization reactor occur continuously. And the crystallization reactor has no oscillatory devices inside the pipe.

### BRIEF DESCRIPTION OF THE INVENTION

The invention describes a process for synthesizing zeolite nanoparticles in a continuous flow system consisting of modules for each stage of the process (FIG. 1).

More specifically, the invention refers to a system consisting of three modules: (i) a microfluidics mixer system (FIG. 2); (ii) a buffer system for mixing the solution from the mixer system with a seed gel (FIG. 3); and (iii) a tubular hydrothermal system for carrying out a hydrothermal process for crystallization of the material (FIG. 4). The modules can be used isolated or integrated, through pumps and piping, to form a complete continuous system.

The module i, called “microfluidics mixer system” (FIG. 2), refers to a two-fluid mixing system. It consists of two pumps (B1 and B2) for solutions S1 and S2; an ice bath (BG); a microfluidic micromixer (FIG. 5), consisting of two inlets (A1, A2) and one outlet (D), resistant to corrosive fluids and high pressure; connections and piping. Its function is the mixture of solutions S1 and S2, composed of Al, NaOH and water and Si, NaOH and water, respectively.

The module ii, called the “buffer system” (FIG. 3), consists of an apparatus that receives fluid S4 from module i and a seed gel S3, mixing the two fluids. It consists of a pump (B3), a container subjected to stirring, connections and piping. The function of the “buffer system” is to homogenize the fluids and provide the necessary residence time for the aging of the solution (promotion of the chemical reactions involved in the formation of zeolites).

The module iii (FIG. 4), called “tubular hydrothermal system”, refers to the system for carrying out the hydrothermal process. It consists of a pump (B4) for transporting fluid S5 from module ii; a pipe (T), made of material resistant to corrosion and high pressure; a suitable heating controller system for the pipe, with temperature monitoring (CT); a pressure control and monitoring system, through a valve coupled to the fluid outlet end (V); container for the outlet fluid; and piping connections. Its function is to crystallize the zeolite nanoparticles.

### BRIEF DESCRIPTION OF THE FIGURES

To obtain a visualization of the object of this invention, the figures are presented which, in a schematic way and not limiting the scope of the model, represent an example of its embodiment:

FIG. 1 presents a schematic design of the integrated synthesis process system, with modules i, ii and iii;

FIG. 2 shows a schematic drawing of module i, the microfluidics mixer system, with the inlet solutions (S1 and S2), two pumps (B1 and B2), device (DNZ) in an ice bath (BG) and the fluid outlet reservoir (S3);

FIG. 3 shows a schematic drawing of module ii, buffer system, with solutions S3 from module i and seed gel S4 transported by pump B3, mixed in a flask subjected to magnetic stirring (AM), resulting in solution S5;

FIG. 4 is a schematic drawing of module iii, hydrothermal system, with the solution S5 from module ii, fed to the T pipe by pump B4, with a heating controller system (CT), a pressure control and monitoring system (V), container for the outlet fluid, connections and piping;

FIG. 5 shows a top view of the schematic design of the three-dimensional microfluidic mixer type crossing channels 3D (DNZ), which consists of at least two inlet channels; at least two independent side inlets (A1; A2) in the form of an epsilon, for the entry of reagents; serial sets of three-dimensional microchannels (B), which divide, recombine and mix the fluids, which are repeated, forming a mirror geometry (C), to guarantee the necessary residence time to carry out the mixing and nucleation process and a channel of mixer outlet (D);

FIG. 6 illustrates the streamlines colored by the mass fraction of the Al solution (Al+NaOH+H₂O), obtained from the CFD simulation of the microfluidic mixer;

FIG. 7 shows the result of X-ray diffraction (XRD) of the sample synthesized in Example 4 (batch) of the present invention;

FIG. 8 shows the result of granulometric distribution, referring to the mean hydrodynamic diameter and polydispersity, of the sample synthesized in Example 4 (batch) of the present invention;

FIG. 9 shows the result of X-ray diffraction (XRD) of the sample synthesized in Example 5;

FIG. 10 shows two scanning electron microscopy (SEM) images of the sample synthesized in Example 5 of the present invention;

FIG. 11 shows the result of granulometric distribution, referring to the mean hydrodynamic diameter and polydispersity, of the sample synthesized in Example 5 of the present invention;

FIG. 12 shows four transmission electron microscopy (TEM) images of the sample synthesized in Example 5;

FIG. 13 shows the result of mapping by Energy Dispersive Spectroscopy (EDS) in Scanning Transmission Electron Microscopy (SEM) equipment of the sample synthesized in Example 5 of the present invention;

FIG. 14 shows the result of X-ray diffraction (XRD) of the sample synthesized in Example 6 of the present invention;

FIG. 15 shows the result of transmission electron microscopy (TEM) of the sample synthesized in the example of implementation of the invention referred to as “Synthesis application 2: mixing modules and hydrothermal process”;

FIG. 16 shows the result of X-ray diffraction (XRD) of the sample synthesized in Example 7 of the present invention;

FIG. 17 shows a scanning electron microscopy (SEM) image of the sample synthesized in Example 7 of the present invention;

FIG. 18 shows the result of granulometric distribution, referring to the mean hydrodynamic diameter and polydispersity, of the sample synthesized in Example 7 of the present invention.

### DETAILED DESCRIPTION OF THE INVENTION

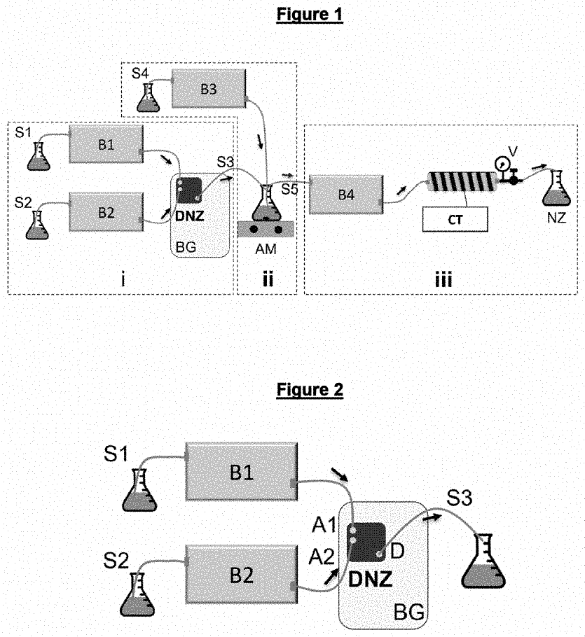

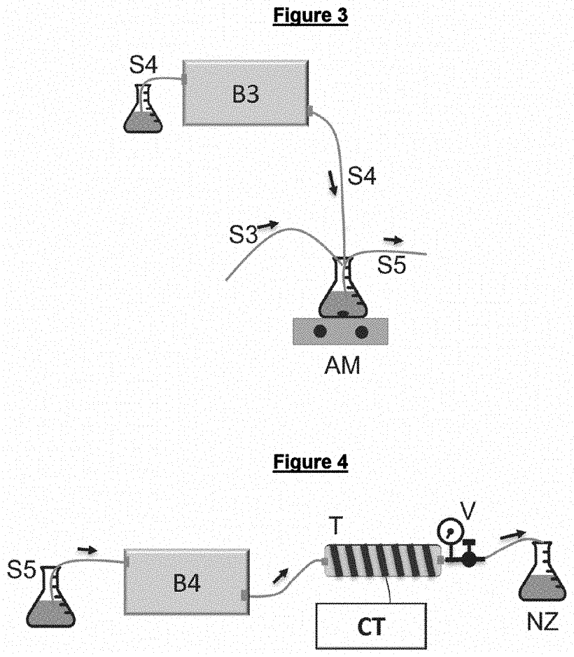

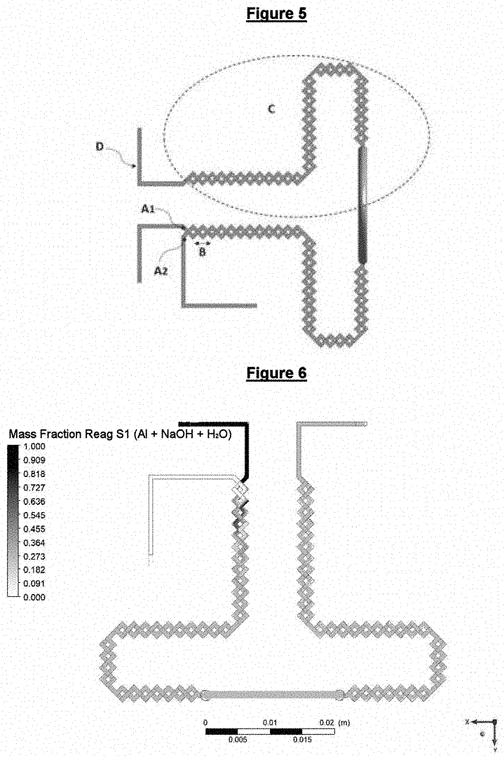

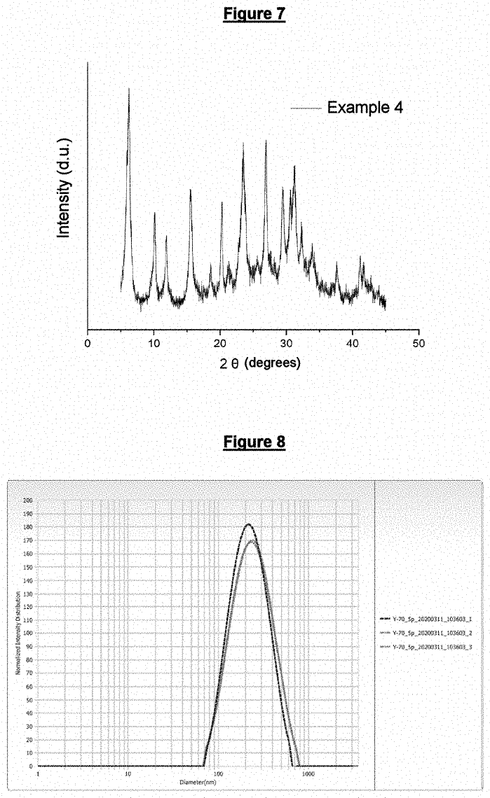

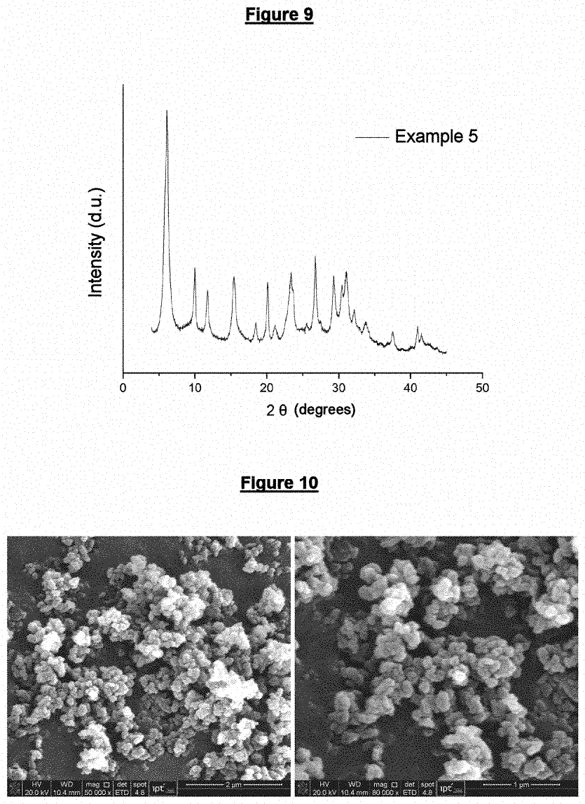

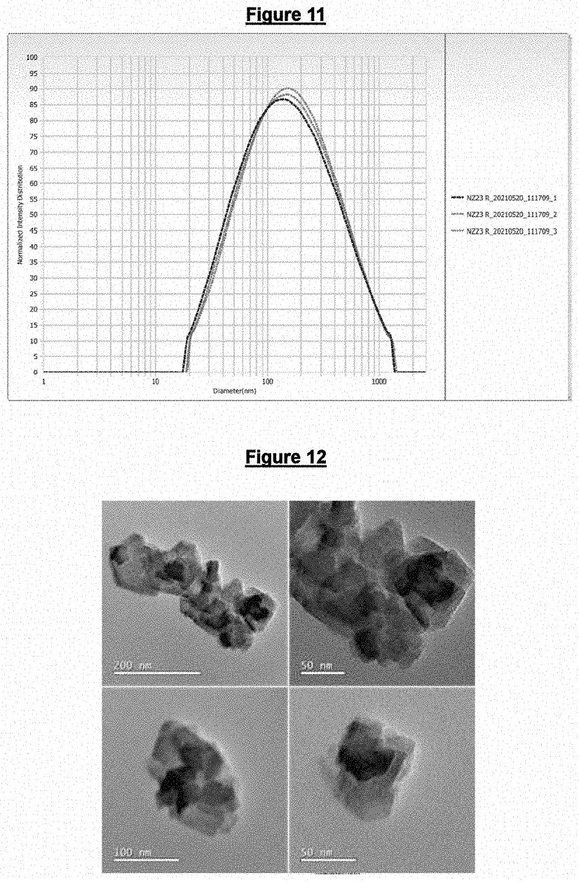

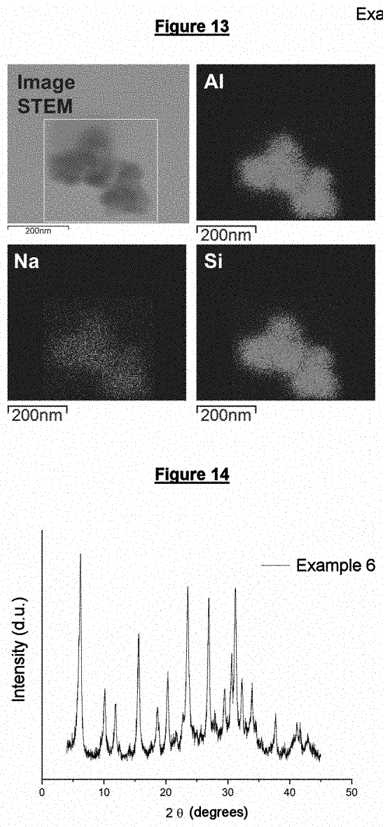

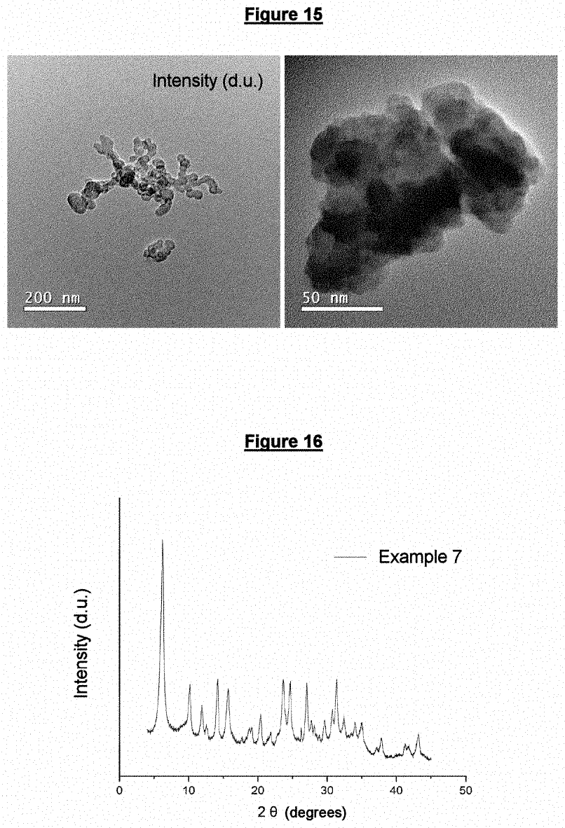

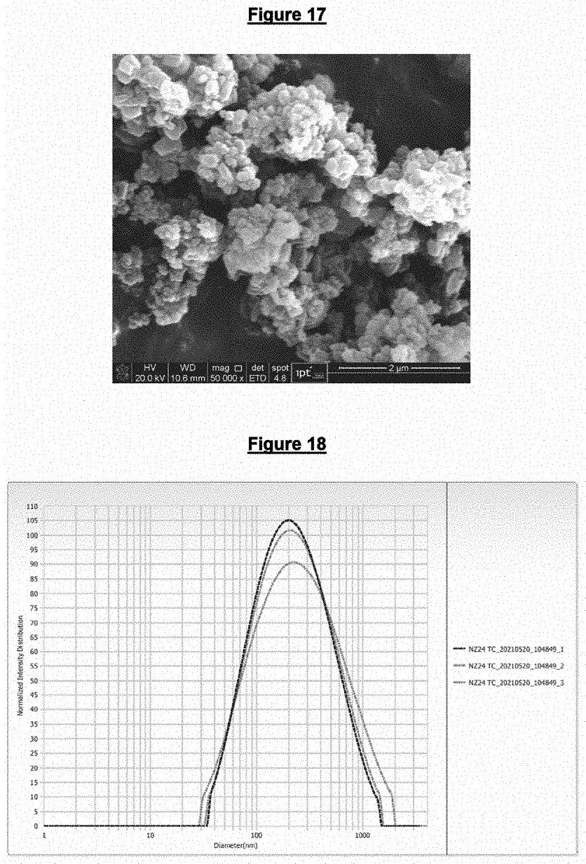

The invention describes a synthesis system for zeolite nanoparticles (FIG. 1), consisting of: a microfluidics mixer system with a microfluidic micromixer structured to generate the mixture of solutions, built in ceramic material that provides resistance to the system, being easy to operate and that allows reuse; an intermediate buffer system, for mixing the solution from the microfluidic system with a new solution; and a tubular system heated to a temperature of 170° C. and pressurized at up to 15 bar (1.5 MPa), for carrying out a hydrothermal process.

The module i, called a microfluidics mixer system (FIG. 2), consists of two pumps (B1 and B2) and a passive microfluidic micromixer (DNZ) of 3D crossing channels type (FIG. 5), characterized by comprising a body that can be built, among other materials, in green ceramic using LTCC technology, which provides high resistance to the same, with at least two inlets (A1, A2) and one material outlet (D), which produces materials with a high degree of mixing (FIG. 6).

The 3D crossing channels type microfluidic micromixer (FIG. 5) comprises a plurality of serial sets (sections) (B) of microchannels for mixing reagents by inducing chaotic advection and multiple lamination of fluids in microchannels. The number of sections is defined as a function of the degree of mixing and the residence time required for the mixing and nucleation processes. The degree of mixing is controlled by the geometry, dimensions of channels and/or cavities, number of sections (B) and applied flow rates.

The microfluidic micromixer is formed by two segments (C) joined by an external connection. Through this connection, optionally, a new fluid can be included, for example, alumina or silica, aiming at controlling the Si/Al molar ratio of the mixture. In this case, a new pump and its proper piping and connections are included.

The microfluidic micromixer has the differential of performing an efficient mixing of reagent solutions, in continuous flow, in the production process of Y-type nanozeolites. It is applicable for fluids with Reynolds number that characterize the flow of fluids in the laminar regime. The mixing efficiency is favored by the induction of chaotic advection by changing the direction of the fluid and by the multiple lamination process, due to the splitting and recombination (SAR—Split and Recombine) of the fluidic streams in the microchannels.

The module ii, called the buffer module (FIG. 3), essentially consists of an intermediate process container. It receives the fluid S3 from module i (microfluidics mixer system) and the seed of zeolite crystals S4 from pump B3. It has the function of homogenizing the fluids and providing the necessary residence time of the solution for the aging of the solution (promotion of the chemical reactions involved in the formation of zeolites). The product from module ii is pumped into module iii.

Specifically, the buffer module is formed by: a pump B3, for fluid displacement, preferably with a double piston; a container that receives the two fluids, made of non-corrosive and inert material, preferably PTFE; a stirrer system for the fluid in the container, magnetic or mechanical, preferably mechanical; connections and piping.

The module iii, called tubular hydrothermal system (FIG. 4), consists of a pipe as the central element, in which the hydrothermal process is carried out aiming at the crystallization of zeolite nanoparticles.

The tubular hydrothermal system comprises: a high-pressure pump B4, preferably with a double piston; a pipe (T), stainless steel or polytetrafluoroethylene (PTFE), inner diameter between 1/16 in. (1.5875 mm) and 1 inch (25.4 mm), preferably inch (12.7 mm), a heating system, through a thermal bath or heating tape, with temperature monitoring; a pressure control system, through a valve coupled to the fluid outlet end, preferably of the back pressure type; piping connections. Its function is to crystallize the zeolite nanoparticles.

The system is pressurized with a back pressure type valve to avoid evaporation, clogging and increased times for crystallization or the formation of zeolite structures different from Faujasite due to the absence of pressure in the system.

Thus, the present invention has the differential of presenting a complete system for the synthesis of zeolite nanoparticles in continuous flow, with all synthesis steps integrated, with a total time of up to 2 hours.

The present invention is not limited to the application in the synthesis of Y-type Faujasite nanozeolites, since the synthesis method and the temperature range practiced are applicable to obtaining other types of nanozeolites, provided that the chemical composition is changed according to the type of zeolite intended, and further, if necessary, the system allows the adjustment of configurations and operating conditions.

As to the equipment and materials used:
microfluidic micromixer produced for mixing reagents that can be built from materials and/or technologies such as polydimethylsiloxane (PDMS), polymethylmethacrylate (PMMA), green glass ceramic (green tape) by the Low Temperature Co-fired Ceramic (LTCC) technique, glass and/or their combination;
pumps for feeding, dispensing and/or dosing fluids, which can be of the double piston, dosing and/or syringe type, not limited to just this form of pumping;
piping made with resistant and inert material, in stainless steel or PTFE, not limited to this type of material;
connections for fixing the pipes for the inlet and outlet of fluids from the devices of the different modules, preferably made of stainless steel;
heating tape for pipes with an outer diameter of in. (12.7 mm), with temperature control up to 200° C.;
back pressure type pressure regulator valve, with internal parts in stainless steel, resistant to a temperature of at least 150° C. and a pressure of at least 10 bar (1 MPa);
line manometer for pressure measurement of at least 15 bar (1.5 MPa).

The method for synthesizing zeolite nanoparticles in continuous flow with a microfluidic micromixer, using the integrated system, comprises the following steps:

(a) Feeding solution S1 (of Al) through pump B1; and the solution S2 (of Si) through the pump B2 to the microfluidic micromixer (DNZ) immersed in an ice bath, continuously, wherein the flow rates of the solution S1 (of Al) and of the solution S2 (of Si) are of 0.1 to 50 mL·min⁻¹ each;

(b) Transferring the mixture obtained in step (a) (S3) to a flask with magnetic stirring, into which a seed suspension of zeolite crystals (S4) is fed through pump B3, wherein the seed flow rate is from 0 to 20% of the microfluidic micromixer (DNZ) flow rate;

(c) Homogenizing the mixture from step (b) (S5);

(d) Transferring the solution resulting from step (c), by means of pump B4, to a pipe for carrying out a hydrothermal process, in which the hydrothermal process operates under operating conditions of: flow rate from 0.2 to 120.0 mL·min⁻¹, pipe surface temperature from 50° C. to 170° C., pressure (vapor pressure and pressure drop associated with the process) from 15 to 220 psi (1 to 15 bar (0.1 to 1.5 MPa));

(e) Washing and drying the product, where the washing to remove residues from the synthesis is carried out by centrifuging at a range of 12,000 to 20,000 rpm in a conical pipe, discarding the supernatant, adding deionized water at room temperature and manual stirring to redisperse the material; repeating the process 5 to 10 times, until the supernatant reaches a pH of 7; at the end, the supernatant is discarded and the sample is frozen for later drying by lyophilization;

(f) After drying, subjecting the material to physicochemical characterizations.

The effluent fluid mixture of module i has the molar proportions of the chemical species in the range of 8-25 Na₂O: 1 Al₂O₃: 9-36 SiO₂: 180-750 H₂O, for application in the synthesis of Faujasite-type nanozeolite.

### Examples

There follows below a detailed description of one of the embodiments of the present invention, by way of example and in no way limiting. Nevertheless, it will be clear to a technician skilled on the subject, from reading this description, possible additional embodiments of the present invention still comprised by the essential and optional features below.

### Example 1: System Assembly Methodology

The module of the microfluidics mixer system was assembled with two double-piston pumps to feed the Al and Si solutions; a 3D crossing channels microfluidic micromixer/microreactor (FIG. 1) immersed in an ice bath, PTFE (polytetrafluoroethylene) tubing with an inner diameter of 1/16 in. (1.5875 mm) and connections in stainless steel.

The microfluidic micromixer for mixing the reagents was developed through computer simulations, applying the Computational Fluid Dynamics (CFD) technique, to define the type of micromixer, its dimensions and the number of sections necessary to increase the mixing efficiency, as shown in FIGS. 5 and 6. Once defined, the micromixer was built by applying the LTCC (Low Temperature Co-fired Ceramic) technology, which has numerous advantages such as electrical and mechanical properties, chemical stability and ease of manufacturing of 3D microchannels. The LTCC microfluidic micromixer was manufactured from glass ceramics, in the form of sheets with a thickness of 250 μm, formed by multiple layers cut by UV laser, according to the desired geometry and characteristics. Subsequently, the multilayers were laminated and sintered at temperatures around 450 to 1000° C. As a result, a passive microfluidic device was obtained with microchannel structures, with 630 μm of hydraulic diameter, which form serial sets of the 3D crossing channels type.

The buffer module was assembled with: a syringe pump, a 50 mL syringe (for the zeolite seed fluid), PTFE (polytetrafluoroethylene) pipe with an inner diameter of 1/16 in. (1.5875 mm), a polypropylene beaker of 250 mL with a magnetic bar and a magnetic stirrer. Pump flow rate can vary, preferably being 10% of the total micromixer flow rate, resulting in a 10% v/v seed ratio.

The hydrothermal system was assembled with: a double piston pump; a 40-cm stainless steel pipe, ½-in. (12.7 mm) outer diameter and 1.24 mm wall; a heating tape (with power regulator) wound over the pipe; a thermocouple coupled to a multimeter to check the temperature on the surface of the pipe; a manometer connected to the pipe outlet; a back pressure type valve connected in sequence to the manometer; a PTFE pipe and a polypropylene flask for collecting the material.

### Example 2: Preparation of Reagent Solutions for the Synthesis Process

Application tests of the synthesis system were carried out, and, initially, the performance capacity of the modules was tested separately. For each test, the necessary reagent solutions for the synthesis of Y-type faujasite zeolite nanoparticles were prepared.

For all application tests, the preparation of reagent solutions followed the overall molar ratio of 8 Na₂O: 0.7 Al₂O₃: 10 SiO₂: 400 H₂O. The reagents are divided into two solutions, Al and Si, respectively, both solubilized in NaOH and H₂O. The reagents used were: aluminum powder (325 mesh, 99.5%) and colloidal silica (Ludox-HS 30, 30% SiO₂ by weight, pH=9.8); sodium hydroxide (NaOH) F.A.; and hydrochloric acid (HCl). The masses used for the Al solution were 26.76 g of NaOH, 60.37 g of deionized water and 2.83 g of Al, and for the Si solution, 21.41 g of NaOH, 51.31 g of deionized water and 151.07 g of colloidal silica. The Si solution was heated at 90° C. in an oven for 15 min to solubilize the silica. The ratio between the final volumes of solutions A and B was 1:3.

### Example 3: Product Washing and Drying

After the synthesis process of the material, described by the synthesis protocols below, the washing to remove the synthesis residues was performed through the following procedure: centrifugation at 15,000 rpm, in a 50 mL conical pipe, discarding the supernatant, addition of about 35 mL of deionized water at room temperature (about 22° C.) and manual stirring to redisperse the material. The procedure was repeated 6 to 8 times, until the supernatant reached a pH of 7. At the end, the supernatant was discarded and the sample was frozen at −80° C. for later drying by lyophilization. After drying, the material was subjected to physicochemical characterizations.

### Example 4: Application of Traditional Batch Synthesis

As an experiment for comparative purposes, synthesis of faujasite zeolite was carried out using the traditional batch method. The Al and Si solutions, prepared as described in Example 2, were mixed by dropping the Al solution to the Si solution, at a rate of approximately 1.2 mL·min⁻¹, in a polypropylene beaker inserted in an ice bath, under gentle mechanical stirring, with a PTFE rod. At the end of the addition of Al, stirring was stopped and the resulting solution was allowed to stand at a temperature of 22° C. for 24 h. Then, the solution was transferred to a PTFE reactor, to carry out a hydrothermal process. The reactor was closed with a lid, enclosed in a stainless-steel support and placed in an oven at 120° C. for 70 min. At the end, the product was washed and dried, as described in Example 3.

The sample obtained was characterized by X-ray diffraction (XRD), as shown in FIG. 7. The result shows the crystalline phase with peaks at 2θ angles characteristic of the faujasite phase of the zeolite, with a crystallite size of 17.3 nm, determined by the Scherrer formula. Through characterization by dynamic light scattering (DLS), shown in FIG. 8, a mean hydrodynamic diameter of 194.6 nm was obtained.

### Example 5: Synthesis Application 1: Mixing Module

An application test was carried out only for the microfluidics mixer system module, with the rest of the synthesis carried out in a traditional way, called batch. After mixing, the solution was subjected to aging by being allowed to stand for 20 h at an ambient temperature of 22° C., and to a hydrothermal process in a closed PTFE reactor, enclosed in a stainless-steel support, in an oven at 120° C. for 70 min.

The pumps were positioned side by side, facing the flasks of solutions S1 and S2, both of which were connected to pumps B1 and B2 through PTFE pipes; the device was also connected to the pumps through a PTFE pipe, connected to the two inlets (A1 and A2); the device was inserted into an ice bath; and the mixture collection flask was also connected to the device through a PTFE pipe. The assembly is shown in FIG. 2.

The test was carried out at a total flow rate of 1.0 mL·min⁻¹ in the device, with the Al solution flow rate being 0.25 mL·min⁻¹ and that of the Si solution being 0.75 mL·min⁻¹.

The X-ray diffraction analysis of the sample, shown in FIG. 9, contains the peaks at 2θ angles characteristic of the faujasite phase of the zeolite, with a crystallite size of 14.5 nm, calculated using the Scherrer equation. Through the Scanning Electron Microscopy (SEM) images, presented in FIG. 10, it is possible to observe that the sample presented particles with a mean size of 96.17 nm ±19.8 nm, irregular in shape, but approximately spherical in general. The result corroborates the analysis of dynamic light scattering (DLS), presented in FIG. 11, of the result of a mean hydrodynamic diameter of 105.5 nm. The transmission electron microscopy (TEM) images, presented in FIG. 12, show that particles are formed by several crystallites of the order of 10 to 20 nm united in a larger particle of the order of 100 nm. This finding confirms the crystallite size results verified by XRD and the particle size analyzed by SEM and DLS. In the two microscopy analyses, the relative atomic proportions of the sample were also verified, and in the SEM measurement, the Si/Al molar ratio was 1.52, while in the MET measurement, it was 1.36. With the TEM equipment, it is also possible to verify the distribution of Si, Na, and Al atoms in the particles, through EDS mapping in the transmission scanning mode (STEM), shown in the images of FIG. 13; the atoms are uniformly distributed in the delimited area of the particles observed in the STEM image, which confirms that the particles have a homogeneous composition.

### Example 6: Synthesis Application 2: Mixing Modules and Hydrothermal Process

An application test of the mixer system module by microfluidics was carried out, with a period of 20 h of aging of the solution allowed to stand and application of the hydrothermal system module.

The mixing protocol in the microfluidics mixer system module was the same as described above, in Example 5.

After the resulting solution is allowed to stand for 20 h, the hydrothermal process was carried out using the tubular hydrothermal module, as shown in FIG. 4. The operating conditions were: flow rate of 4.0 mL·min⁻¹, temperature of the surface of the pipe at 130° C., pressure at 30 to 40 psi (206.8 to 275.8 kPa).

According to analysis through X-ray diffraction measurement, shown in FIG. 14, it is concluded that crystalline faujasite zeolite was obtained, with a crystallite size of 20.0 nm. The TEM analysis, shown in FIG. 15, shows the crystallites forming the zeolite particles.

### Example 7: Summary Application 3: Integrated (Complete) Streaming System

A process of synthesis of zeolite nanoparticles was carried out to evaluate the integrated system in continuous flow.

The assembly scheme is shown in FIG. 1 and consists of: pump B1 to feed the Al solution (S1), pump B2 to feed the Si solution (S2), a micromixer/microfluidic microreactor immersed in an ice bath, pump B3 to feed the seed suspension (S4), a flask under magnetic stirring to receive the mixture solution (S3) and the seed (S4) and homogenize this new mixture, pump B4 to feed this homogeneous mixture, stainless steel pipe (½ in. (12.7 mm), 40 cm), heating tape for the pipe, thermocouple and multimeter for recording the temperature on the surface of the pipe, manometer and back pressure valve, in addition to the connecting pipes, stainless steel connections and bottles of initial solutions and products.

The total flow rate in the device was 1.2 mL·min⁻¹, with 0.3 mL·min⁻¹ of the Al solution and 0.9 mL·min⁻¹ of the Si solution; the seed flow rate was 10% of the microfluidic micromixer flow rate, therefore 0.12 mL·min⁻¹. About 1 h after the beginning of mixing (time for the formation of sufficient volume for the pump B4 to operate), the hydrothermal process was started, with a flow rate of 2 mL·min⁻¹ and a target temperature of 130° C.

The visual analyses of the samples produced by the synthesis system showed the generation of visually homogeneous, opaque, whitish mixtures. In the X-ray diffraction analysis (FIG. 16), the sample generated from the process showed the main peaks of the faujasite phase, with impurity peaks of reduced intensity. The crystallite size calculated using the Scherrer equation was 16.5 nm, similar to the result obtained by batch, of 17.3 nm, described in Example 4.

The SEM images are registered in FIG. 17. Note the majority presence of approximately spherical particles, but there are also particles of more elongated morphology. Computing only those with the closest spherical morphology, the mean particle diameter was 97.7 nm ±22.8 nm. According to the EDS result, the verified Si/Al molar ratio was 1.41.

The DLS result is recorded in FIG. 18. The mean hydrodynamic diameter obtained was 168.3 nm. The result is smaller, but similar to the batch result of 194.6 nm described in Example 4.

Using the integrated system with the three modules, in a process that takes less than 2 hours to obtain the products, nanoparticles of faujasite zeolite were formed, proving the feasibility of applying the system in the synthesis of Y zeolite in continuous flow.

In short, the present invention allows each of the steps that make up the synthesis of production of zeolite nanoparticles (nanozeolites) in continuous flow, to have their parameters adjusted according to the type of zeolite to be produced.

The development of the mixing step applying microfluidic technology and the addition of seeds ensure the reduction of aging time without affecting the quality of the nanozeolite produced through continuous flow synthesis.

The decrease in the aging time, in the synthesis of nanozeolites in continuous flow, allows the increase of the production of nanozeolites.

1. A SYSTEM FOR SYNTHESIS OF ZEOLITE NANOPARTICLES IN CONTINUOUS FLOW WITH MICROFLUIDIC MICROMIXER, characterized in that it comprises three integrated modules, which are (i) a microfluidics mixer system, (ii) an intermediate buffer system and (iii) a tubular hydrothermal system, wherein:
the module i comprises two pumps (B1, B2); a microfluidic micromixer (DNZ), for mixing the reagents, consisting of two independent inlets (A1, A2) for material inlet, serial sets of three-dimensional microchannels (B); a material outlet (D); connections and piping;
the module ii comprises a pump (B3), a container subjected to stirring, piping and connections to receive the fluid from module i and a seed gel, performing the homogenization of the two fluids and providing the necessary residence time for the resulting solution, for aging the solution and sending the solution to module iii;
the module iii comprises a pump (B4); a pipe (T); a heating system with temperature monitoring (CT) for the pipe (T); a pressure control and monitoring system through a regulating valve (V) coupled to the fluid outlet end;
connections and piping for carrying out the crystallization of zeolite nanoparticles.

2. THE SYSTEM according to claim 1, characterized in that the mixture of fluids in module i is a mixture of two solutions, one of Al, NaOH and water and another of Si, NaOH and water.

3. THE SYSTEM according to claim 1, characterized in that the microfluidic micromixer of module i is of the 3D crossing channels type.

4. THE SYSTEM according to claim 1, characterized in that the microfluidic micromixer (DNZ) of module i is built of materials chosen from polydimethylsiloxane (PDMS), polymethylmethacrylate (PMMA), green glass ceramic (green tape) by the Low Temperature Co-fired Ceramic (LTCC) technique, glass, and/or a combination thereof.

5. THE SYSTEM according to claim 1, characterized in that the pumps (B1, B2, B3 and B4) are precision pumps, suitable for feeding the mixer module by microfluidics, intermediate buffer and tubular hydrothermal.

6. THE SYSTEM according to claim 1, characterized in that the pipe (T) of module iii has an inner diameter between 1/16 in. (1.5875 mm) and 1 in. (25.4 mm), preferably ½ in. (12.7 mm).

7. THE SYSTEM according to claim 1, characterized in that heating system (CT) of module iii is a heating tape for pipes with an outer diameter of ½ inch (12.7 mm), with temperature control of up to 200° C.

8. THE SYSTEM according to claim 1, characterized in that the valve (V) of module iii is of the back pressure type, with internal parts in stainless steel, resistant to a temperature of at least 150° C. and a pressure of at least 10 bar (1 MPa).

9. THE SYSTEM according to claim 1, characterized in that the pressure control and monitoring system (V) of module iii is a line manometer for pressure measurement of at least 10 bar (1 MPa).

10. THE SYSTEM according to claim 1, characterized in that the piping are made of resistant and inert material, in stainless steel or PTFE.

11. THE SYSTEM according to claim 1, characterized in that the connections for fixing the pipes for the inlet and outlet of fluids from the devices of the different modules are preferably made of stainless steel.

12. A METHOD FOR SYNTHESIS OF ZEOLITE NANOPARTICLES IN CONTINUOUS FLOW WITH MICROFLUIDIC MICROMIXER, using the integrated system as defined in claim 1, characterized in that it comprises the following steps:
(a) Feeding solution S1 (of Al) through pump B1; and the S2 solution (of Si) through pump B2 to the microfluidic micromixer (DNZ) immersed in an ice bath, continuously;
(b) Transferring the mixture obtained in step (a) (S3) to a flask with magnetic stirring, into which a seed suspension of zeolite crystals (S4) is fed by means of pump B3;
(c) Homogenizing the mixture from step (b) (S5);
(d) Transferring the solution resulting from step (c), by means of pump B4, to a pipe to carry out a hydrothermal process;
(e) Washing and drying the product;
(f) After drying, subjecting the material to physicochemical characterizations.

13. THE METHOD according to claim 12, characterized in that the flow rates of solution S1 (of Al) and solution S2 (of Si) being 0.1 to 50 mL·min⁻¹ each.

14. THE METHOD according to claim 12, characterized in that the mixture of effluent fluids from module i has the molar proportions of the chemical species in the range of 8-25 Na₂O: 1 Al₂O₃: 9-36 SiO₂: 180-750 H₂O, for application in the synthesis of nanozeolite of the Faujasite type.

15. THE METHOD according to claim 12, characterized in that the seed flow rate being from 0 to 20% of the flow rate of the microfluidic micromixer (DNZ).

16. THE METHOD according to claim 12, characterized in that the hydrothermal process operating under operating conditions of: flow rate from 0.2 to 120.0 mL·min⁻¹, pipe surface temperature from 50° C. to 170° C., pressure (vapor pressure and pressure drop associated with the process) from 15 to 220 psi (1 to 15 bar (0.1 to 1.5 MPa)).

17. THE METHOD according to claim 12, characterized in that there is the washing to remove residues from the synthesis that is performed by centrifugation in a range of 12,000 to 20,000 rpm in a conical pipe, discarding the supernatant, adding deionized water at room temperature and manual stirring to redisperse the material; repeating the process 5 to 10 times, until the supernatant reaches a pH of 7; at the end, the supernatant is discarded and the sample is frozen for later drying by lyophilization.
